(19) United States
(12) Patent Application Publication
(10) Pub. No.: US 2017/0111158 A1
(43) Pub. Date: Apr. 20, 2017

(54) CONFIGURABLE SENSOR TRAP

(71) Applicant: Elephant Head, Inc., Denver, CO (US)

(72) Inventor: Aditya Nagrath, Denver, CO (US)

(21) Appl. No.: 15/297,741

(22) Filed: Oct. 19, 2016

Related U.S. Application Data
(60) Provisional application No. 62/243,419, filed on Oct. 19, 2015.
(60) Provisional application No. 62/243,409, filed on Oct. 19, 2015.

(51) Int. Cl. H04L 5/00; H04L 12/933

(52) U.S. Cl. CPC H04L 5/0096; H04L 49/1584; H04L 45/745

(57) ABSTRACT

A configurable sensor trap is described that comprises a plurality of translation modules stored in a memory, each of which is dynamically associable with one or more of a plurality of pins of a processor. The translation modules allow the configurable sensor trap to be quickly configured to translate sensor data from any of a variety of incoming signal formats into a desired output signal format before the data is transmitted to the cloud.

### CROSS REFERENCE TO RELATED APPLICATIONS

The present application claims, under 35 U.S.C. §119(e), the benefits of and priority to U.S. Provisional Application Ser. No. 62/243,419, filed on Oct. 19, 2015, entitled “Configurable Sensor Trap,” and U.S. Provisional Application Ser. No. 62/243,409, filed on Oct. 19, 2015, entitled “Self-Promoting Mesh Network Node,” the disclosures of which are hereby incorporated by reference in their entirety for all that they teach and for all purposes.

### FIELD

The present disclosure is generally directed to the collection of data from sensors and more specifically to a device configured to be connected to multiple sensors of the same or different types.

### BACKGROUND

Many industrial assets are equipped with sensors to track operating performance and/or conditions. However, data from these sensors must often be checked or collected manually. In some instances, industrial assets are equipped with sensors that were designed and built before wireless networking technology was available or economical. In other instances, industrial assets may have been equipped with non-networked sensors due to cost or because, at the time the industrial asset was built or outfitted with sensors, networked sensors were viewed as unnecessary. In still other instances, industrial assets are equipped with sensors and/or actuators that are part of a wired network, but there has not been a practical or economical way to transfer data from the wired network to the cloud, where data from the network can be made more widely available and more easily accessible, or vice versa.

### SUMMARY

While some efforts have been made to retrofit existing industrial assets with networked sensors from which data can be collected automatically and in real time, and with networked actuators to which commands can be sent via the Internet in real time, such efforts are context-specific, such that a system designed for one industrial asset cannot be implemented for a different industrial asset. Consequently, such retrofitting projects are expensive and time-consuming. As persons skilled in the art will recognize, sensors come in a variety of shapes and sizes, and may be configured to output data in a variety of formats using a variety of protocols. Common protocols that may be used in conjunction with sensors include but are not limited to RS-232, RS-422, RS-485, CAN bus, INTERBUS, Modbus, I²C, SPI, UART, and USART. Given the wide variety of protocols that might be encountered across different applications, a sensor trap that can be quickly configured to handle any particular protocol or group of protocols may beneficially allow reduced installation and setup times, with a corresponding saving of resources.

Additionally, mesh networks may be advantageously used to economically gather data from one or more sensors in a given system, whether an industrial asset or elsewhere, and to economically send commands to the sensors or to one or more actuators in the system. A mesh network is a network topology comprising a plurality of nodes, where each node relays data for the network. The nodes in the network cooperate to distribute data in the network. Data can be distributed using a flooding or broadcast technique, where a message is sent to every node in the network regardless of whether a particular node is an intended recipient of the message, or using the routing technique, where the message is sent from one node to another until it reaches the intended recipient node. Nodes in a mesh network may operate as a data source or end node (placing new data on the mesh network, or receiving commands through the mesh network), a data forwarder or coordinator node (transmitting data from one node to another on the mesh network), or a data sink or router (receiving data from various nodes on the mesh network, and in some instances, transmitting that data from the mesh network to a different network (e.g. the Internet) or location (e.g. a server or data storage facility)).

In accordance with embodiments of the present disclosure, a configurable sensor trap may be coupled to a sensor such that the sensor trap receives data from the sensor and/or passes commands to the sensor. The sensor trap may be a data source or end node in a mesh network, configured to place the data from the sensor on the mesh network and/or to send the data via the mesh network to a data sink or router on the mesh network.

A sensor trap as disclosed herein can be connected to multiple sensors of the same or different types. The sensor trap allows sensor data to be sent via a mesh network to a data sink and then into the cloud, from where it can be accessed or distributed as needed. The sensor trap also allows commands to be sent from the cloud to the sensor via the mesh network.

According to one embodiment of the present disclosure, a configurable sensor trap, includes a processor, at least one port, a memory, and a communication interface. The processor comprises a plurality of pins. The at least one port has at least one conducting channel for receiving an incoming signal in one of a plurality of first formats, and the conducting channel is electrically coupled to at least one of the plurality of pins. The memory stores a plurality of translation modules, each translation module containing instructions for causing the processor to translate a signal from one of the plurality of first formats to a second format. Each translation module is dynamically associable with at least one of the plurality of pins. The communication interface transmits signals in the second format across a network.

The communication interface may be configured to receive command signals in a third format from the network. The plurality of translation modules may include at least one translation module containing instructions for causing the processor to translate the command signals from the third format to one of the plurality of first formats. The plurality of first formats may include one or more of RS-232, Modbus, Interbus, and CAN bus. The second format may comprise SPI. The at least one port may be an RJ45 port.

Additionally, the configurable sensor trap may comprise a plurality of ports, each of which may have a plurality of conducting channels. Each of the plurality of conducting channels may be electrically coupled to one of the plurality of pins. The memory may further store instructions for causing the processor to automatically associate one of the plurality of translation modules with the at least one of the plurality of pins electrically coupled to the conducting channel based upon an evaluation of the incoming signal. The evaluation of the incoming signal may comprise comparing a format of the incoming signal to each of the plurality of first formats. The memory of the configurable sensor trap may further store a database of the plurality of first formats.

According to another embodiment of the present disclosure, a sensor system may comprise a plurality of sensors and at least one sensor trap, the sensor trap comprising a processor, a plurality of ports, a memory, and a communication interface. The processor comprises a plurality of pins. The plurality of ports is electrically coupled to one of the plurality of sensors, and each port has a plurality of conducting channels for receiving an incoming signal in one of a plurality of first formats from one of the plurality of sensors. Each of the plurality of conducting channels is electrically coupled to one of the plurality of pins. The memory stores a plurality of translation modules, each of which contains instructions for causing the processor to translate a signal from one of the plurality of first formats to a second format. One of the plurality of translation modules is dynamically associated with each pin that is electrically coupled to one of the plurality of conducting channels. The communication interface transmits signals in the second format across a network.

Additionally, the plurality of first formats may comprise RS-232, Modbus, Interbus, and/or CAN bus. The second format may comprise SPI. The sensor trap may further comprise at least one actuator port electrically coupled to at least one actuator. The communication interface may be configured to receive command signals in a third format from the network, and the plurality of translation modules may include at least one translation module containing instructions for causing the processor to translate the command signals from the third format to one of the plurality of first formats. At least one of the plurality of ports may be an RJ45 port. The plurality of sensors may include at least one of a temperature sensor, a pressure sensor, an audio sensor, an optical sensor, a motion sensor, a location sensor, a chemical sensor, and a biometric sensor. The network may be connected to the Internet.

An end node of a mesh network according to yet another embodiment of the present disclosure comprises a transceiver for sending signals across and receiving signals from a mesh network; a processor comprising a plurality of pins, each pin dynamically associable with one of a plurality of translation modules stored in a memory, each translation module containing instructions for causing the processor to translate a signal from an input format to an output format; and a sensor or an actuator electrically coupled to at least one of the plurality of pins via a port. The signals received from the sensor or the actuator in the input format are translated to the output format and sent across the mesh network by the transceiver, and signals received by the transceiver from the mesh network in the output format are translated to the input format and sent to the sensor or the actuator.

The terms “memory,” “computer memory,” and “computer-readable medium,” as used herein, refer to any tangible data storage medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read instructions. When the computer-readable medium is configured as part of a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The terms “determine,” “calculate,” and “compute,” and variations thereof, as used herein, are used interchangeably and include any type of methodology, process, mathematical operation, or technique.

The term “module” as used herein refers to any known or later developed hardware, software, firmware, artificial intelligence, fuzzy logic, or combination of hardware and software that is capable of performing the functionality associated with that element.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a sensor trap and associated sensors according to one embodiment of the present disclosure;

FIG. 2 is a block diagram of a memory of a sensor trap according another embodiment of the present disclosure;

FIG. 3 is a diagram of a mesh network according to another embodiment of the present disclosure;

FIG. 4 is a block diagram of a sensor trap and associated actuators and sensor according to yet another embodiment of the present disclosure;

FIG. 5 depicts an implementation of aspects of the present disclosure in a trucking environment; and

FIG. 6 depicts another implementation of aspects of the present disclosure in a factory environment.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Additionally, the use of phrases denoting examples (including “for example,” “by way of example,” “e.g.,” “such as,” and other similar phrases) indicates that what follows is only one example of a feature or aspect of the present disclosure, and is not intended to be limiting.

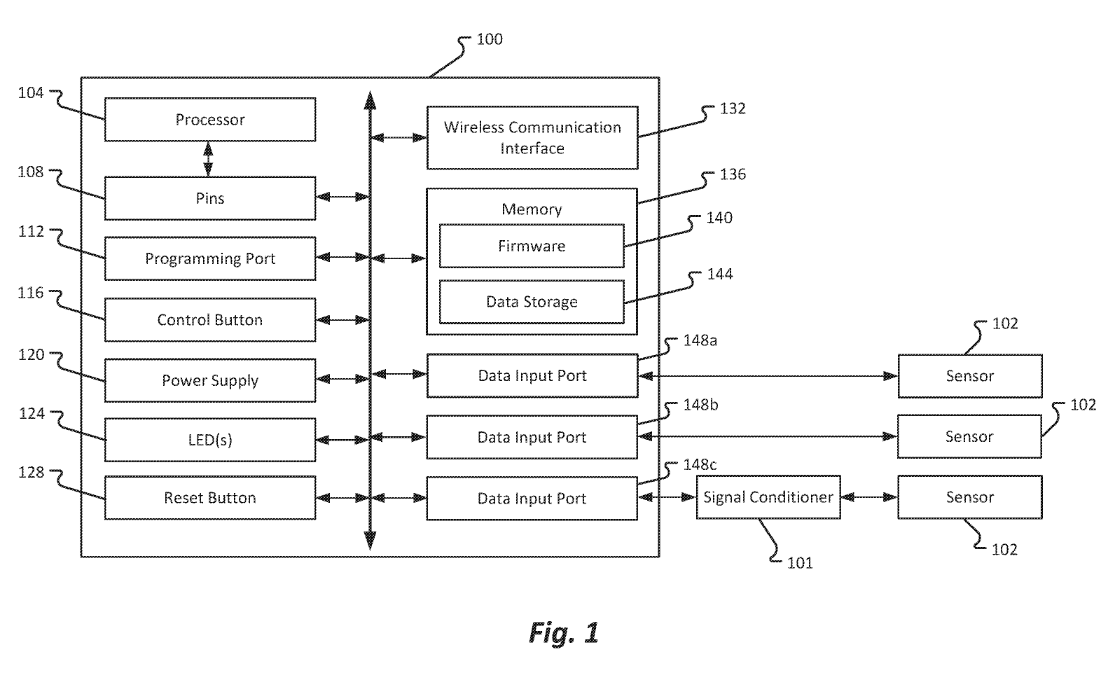

Referring first to FIG. 1, a sensor trap 100 according to one embodiment of the present disclosure includes a processor 104 with a plurality of pins 108 that can be dynamically reconfigured. The sensor trap 100 also includes a programming port 112, a control button 116, a power jack 120, one or more Light-Emitting Diodes (LEDs) 124, and a reset button 128. The sensor trap 100 further includes a wireless communication interface 132, a memory 136, and one or more data input ports 148, to each of which a sensor 102 may be connected. In some embodiments, the sensor trap 100 comprises a system-on-a-chip.

The processor 104 may correspond to one or multiple microprocessors that are contained within the housing of the sensor trap 100. The processor 104 may comprise a Central Processing Unit (CPU) on a single Integrated Circuit (IC) or a few IC chips. The processor 104 may be a multipurpose, programmable device that accepts digital data as input, processes the digital data according to instructions stored in its internal memory, and provides results as output. The processor 104 may implement sequential digital logic as it has internal memory. As with most known microprocessors, the processor 104 may operate on numbers and symbols represented in the binary numeral system.

The control button 116, reset button 128, and LEDs 124 facilitate setup and troubleshooting of the sensor trap 100 by an operator thereof. For example, different inputs via the control button 116 (which may be any type of button or switch that opens and closes an electrical connection, or that causes an electrical connection to be opened or closed) may cause different electrical signals to be sent to the processor 104. The inputs may be, for example, a short press, a long press, or various combinations thereof. Each input may generate (or cause to be generated) a unique electrical signal, and each unique electrical signal may cause the processor 104 to execute a different instruction or set of instructions. The control button 116 may be thus used, for example, to turn the sensor trap on or off; to cause the processor 104 to cause the wireless communication interface 132 to establish a connection with a network or a device; to turn on or off a data input port 148a, 148b, or 148c; to assign one or more pins 108 to the conducting channel(s) of a data input port 148a, 148b, or 148c; and/or to associate a translation module with the pins 108 that are assigned to the conducting channel(s) of one of the data input ports 148a, 148b, or 148c.

The LEDs 124 may be used to provide status information and/or feedback to an operator of the sensor trap 100. For example, the LEDs 124 may show a flashing green light when the sensor trap 100 is powering up and/or when the wireless communication interface 132 is attempting to establish a wireless connection with a network or device. The LEDs 124 may show a steady green light when the sensor trap 100 is operating normally. Additionally, the LEDs 124 may blink or flash red, orange, and/or yellow in various patterns that may be associated with different status or error messages. A blinking red light, for example, may indicate that the sensor trap 100 is not receiving any information via the data input ports 148 thereof. A blinking yellow light may indicate, as another example, that the sensor trap 100 is not communicating over a network or with another device via the wireless communication interface 132.

Further, the LEDs 124 may flash, blink, or otherwise illuminate in response to inputs provided via the control button 116. The LEDs 124 may flash a green light twice to indicate that an input via the control button 116 was recognized, or may flash a red light twice to indicate that an input via the control button 116 was not recognized. The LEDs 124 may also respond to a control input from the control button 116 with a light pattern (which may use colors, blinks/flashes, or both) corresponding to the specific control input that was received, so that the operator can verify that the desired control input has been entered. The LEDs 124 may also provide information in response to a control input so as to allow an operator to select one of several options. For example, each translation module stored in the memory 136 of the sensor trap 100 may be associated with a specific light pattern, which the LEDs 124 may display as an operator of the sensor trap 100 cycles through available translation modules using the control button 116. In this way, the operator can verify that he or she selects the desired translation module for use with data received via a particular data input port 148.

The power supply 120 may comprise a built-in power supply (e.g., battery) and/or a power converter that facilitates the conversion of externally-supplied AC power into DC power that is used to power the various components of the sensor trap 100. In some embodiments, the power supply 120 may also include some implementation of surge protection circuitry to protect the components of the sensor trap 100 from power surges. Also in some embodiments, the power supply 120 may comprise an energy conversion device for converting non-electrical energy into electrical energy. Such a device may be or include, for example, a solar panel, a windmill, a generator, or a combination thereof.

The wireless communication interface 132 may comprise hardware that facilitates communications with other communication devices directly or over a communication network. For example, the wireless communication interface 132 may be used for sending converted sensor data to a data sink/router (whether directly or indirectly), from which it can be uploaded to the cloud and/or sent to another network location. The wireless communication interface 132 may comprise a Wi-Fi card, a Network Interface Card (NIC), a cellular interface (e.g., antenna, filters, and associated circuitry), a Near-Field Communication (NFC) interface, a Radio Frequency Identification (RFID) interface, a ZigBee interface, a FeliCa interface, a MiWi interface, Bluetooth interface, a Bluetooth low energy (BLE) interface, a GSM interface, or the like. In addition to being configured to facilitate communications between the sensor trap 100 and another networked device, the wireless communication interface 132 may be configured to encode and decode communications (e.g., packets) according to a protocol utilized by a network to which the sensor trap 100 belongs. Drivers and/or other information needed or utilized by the wireless communication interface 132 may be stored in the memory 136.

Although the sensor trap 100 is depicted in FIG. 1 as having a wireless communication interface 132, in some embodiments the sensor trap 100 may have a wired communication interface in addition to or instead of the sensor trap 100.

The memory 136 may correspond to any type of non-transitory computer-readable medium. In some embodiments, the memory 136 may comprise volatile or non-volatile memory and a controller for the same. Non-limiting examples of memory 136 that may be utilized in the sensor trap 100 include RAM, ROM, buffer memory, flash memory, solid-state memory, or variants thereof.

The memory 136 stores two broad categories of data, although these categories are not intended to be limiting. For example, the memory 136 stores firmware 140, which comprises instructions for execution by the processor 104 for implementing one or more aspects of the present disclosure. Such instructions may comprise one or more translation modules used to translate or convert information received via the data input ports 148 from one format or protocol to another format or protocol, as further discussed herein.

The memory 136 also comprises a data storage 144, for storing such information as un-used translation modules, information received via the data input ports 148 from one or more sensors 102, drivers for the various components of the sensor trap 100, and settings for the various components of the sensor trap 100 (including, for example, network or device information needed by the wireless communication interface 132 to establish and maintain a connection with a network to which the sensor trap 100 belongs, or with a device with which the wireless communication interface 132 communicates).

The plurality of data input ports 148 may comprise a plurality of types of ports. Possible port types include, but are not limited to, RJ45, 4P4C, 6P6C, USB, Firewire, Apple Lightning, DB9, DB25, and COM. Each data input port 148 may have one or more conducting channels. For example, a data input port 148 may be an RJ45 port, with 8 conducting channels. In embodiments, each conducting channel of the data input port 148 is routed to a separate pin 108 on the processor 104. As persons of ordinary skill in the art will recognize, any data input port 148 may be used to provide a physical connection between an output wire from a sensor 102 and the sensor trap 100, regardless of whether the protocol commonly associated with a particular port type (e.g. USB or Firewire) is used for communications transmitted via the port. A cable or wire having appropriate connectors may be used to connect the data output port of the sensor 102 to the data input port 148 of the sensor trap 102.

Although the sensor trap 100 is depicted in FIG. 1 as having three data input ports 148a, 148b, and 148c, sensor traps according to embodiments of the present disclosure may have only one data input port 148, or any number of data input ports 148 greater than one. In some embodiments, one or more data input ports 148 may be configured to receive data from a sensor 102 via a wireless connection. For example, some data input ports 148 may be configured to receive data from a sensor 102 via Wi-Fi, Bluetooth, Bluetooth Low Energy (BLE), ZigBee, Weigand, RFID, NFC, or any other wireless communication protocol. To accommodate contexts in which some sensors 102 comprise only a wired output while other sensors 102 comprise only a wireless output or both a wired and a wireless output, a sensor trap 100 in some embodiments may include at least one data input port 148 configured for receiving wired communications from a first sensor 102, and at least one data input port 148 configured for receiving wireless communications from a second sensor 102.

The programming port 112 provides a port to which an operator of the sensor trap 100 may connect a computer or similar device for initial programming and setup of the sensor trap 100, maintenance and updating of the sensor trap 100, reconfiguration of the sensor trap 100, and/or retrieval of data from the sensor trap 100. The programming port 112 may be, for example, a USB port, a mini-USB port, an Ethernet port, a Lightning port, or any other suitable port. After connecting a desktop, laptop, tablet, smart phone, or other computing device to the sensor trap 100 via the programming port 112, an operator may use the connected computing device to transfer data (including, for example, instructions for operation of the processor 104) to the memory 136 of the sensor trap 100; set or adjust one or more settings of the processor 104 and/or other components of the sensor trap 100 (e.g. the wireless communication interface 132, and/or the data input ports 148), including which pins 108 are assigned to which conducting channels of data input ports 148 and which translation modules will be executed by the processor 104 for which pins 108; and download (to the connected computing device) data received from one or more sensors 102 via the data input ports 148 and stored in the memory 136 of the sensor trap 100 (regardless of whether such data is also transmitted via the wireless communication interface 132).

The sensors 102 may be any sensors now known or yet to be developed. The sensors 102 may be, by way of example but not limitation, thermocouples or other temperature sensors; pressure sensors; strain gauges; optical sensors; chemical sensors; motion sensors; accelerometers; microphones or other audio sensors; vibration sensors; moisture sensors; current meters; flow meters; flux meters; voltmeters; location sensors; capacitive sensors; and biometric sensors. Where a plurality of sensors 102 are connected to a single sensor trap 100, the sensors 102 may be of the same or different types. In some embodiments, only one sensor 102 may be attached to a sensor trap 100.

If any signal conditioning is needed to render the signals from a sensor 102 readable by the sensor trap 100, that conditioning may be done with a signal conditioner 101 before the signal reaches the data input port 148 of the sensor trap 100. For example, an incoming signal may need to be routed through a signal conditioner 101 such as an amplifier or a noise filter before it is routed to the sensor trap 100.

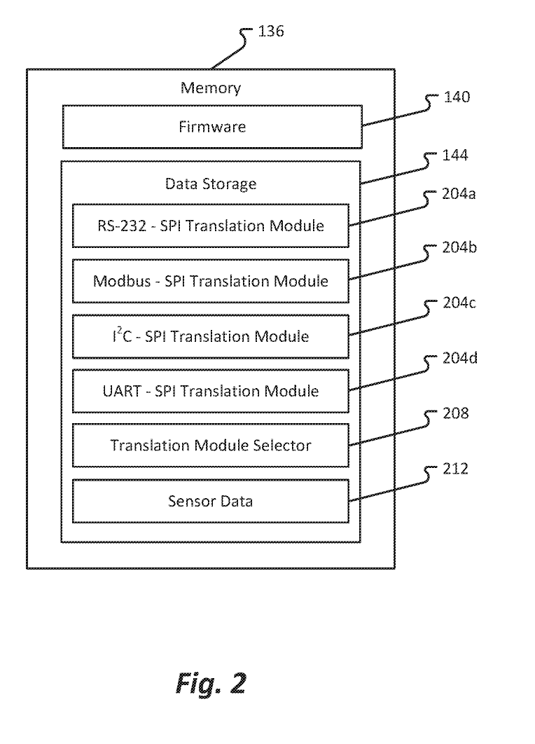

Referring now to FIG. 2, the memory 136 of the sensor trap 100 stores at least a plurality of translation modules 204. Each translation module 204 includes instructions for causing the processor 104 to translate an incoming signal from a first input protocol (e.g. RS-232) to second output protocol (e.g. SPI). Typically, each translation module 204 stored in the memory 136 of a particular sensor trap 100 outputs data in a single desired protocol (e.g. SPI), but each translates data to the desired protocol from a different protocol. Thus, a particular sensor trap 100 may have four translation modules 204 stored in memory, one each configured to translate incoming signals from the RS-232 (translator module 204a), Modbus (translator module 204b), I²C (translator module 204c), and UART (translator module 204d) protocols to the SPI protocol. Any of the plurality of translation modules 204 may be assigned to each pin (or a grouping of pins) on the processor 104 of the sensor trap 100 corresponding to a signal received from a sensor 102 via a data input port 148, and the assignments can be dynamically changed. Thus, for example, while the translation module 204a may be assigned to a specific group of pins (e.g. pins 1-4) during a first time period (e.g. while the sensor trap 100 is being used for a first project), a different translation module selected from translation modules 204b, 204c, and 204d may be assigned to the same pins during a second time period (e.g. while the sensor trap 100 is being used for a second project). As another example, while the translation module 204d may be assigned to a specific group of pins (e.g. pins 1-4) during a first time period, a different translation module selected from translation modules 204a, 204b, and 204c may be assigned to a different but overlapping group of pins (e.g. pins 3-8) during a second time period.

Additionally, the translation modules 204 stored in the memory 136 may be updated or replaced with different translation modules. For example, if a new translation module not currently stored in the memory 136 is needed for a particular use of the sensor trap 100, then the new translation module may be stored in the memory 136 by a computer or other device connected to the sensor trap 100 via the programming port 112. Any number of translation modules 204 may be stored in the memory 136, provided that the memory 136 has sufficient capacity to store the desired number of translation modules 204. When insufficient capacity exists in the memory 136 to store a new translation module 204 therein, an existing translation module (or other non-essential data stored in the memory 136) may be deleted from the memory 136. Additionally, one or more translation modules 204 may be deleted from the memory 136 for any reason, not just to make room for a new translation module 204.

In some embodiments, the translation modules 204 stored in the memory 136 of a sensor trap 100 include instructions for translating an incoming signal into a real-world value. For example, one translation module 204 may be configured to convert an incoming RS-232 signal from a thermocouple into a temperature value (e.g. a signal representative of and readable as a temperature value), while another may be configured to convert an incoming Modbus signal from a pressure sensor into a pressure value (e.g. a signal representative of and readable as a pressure value). The instructions in the translation module 204 may include or refer to a database containing conversion factors or correlations needed to accomplish the conversion properly. In embodiments, the conversion factors or correlations can be updated through a calibration process to ensure that incoming signals are converted properly. In this way, variations in the output signals of different sensors 102 of the same type can be accounted for when converting those output signals into signals representative of real-world values.

As discussed above, a sensor trap 100 as described herein can be quickly configured to properly translate incoming signals from a sensor 102 from an input protocol to an output protocol. For example, a cable from a sensor 102 may be plugged into the data input port 148a on the sensor trap 100, and the data input port 148a may be hard-wired to pins 1-8 of the pins 108 of the processor 104 of the sensor trap 100. If the sensor 102 outputs data in an RS-232 protocol, then the pins 108 on the sensor trap 100 to which the incoming signal is routed can be assigned a translation module 204 that will translate the RS-232 signal into an SPI (or any other desired) signal. Cables from other sensors 102 may be plugged into other data input ports 148 on the sensor trap 100, and the pins 108 to which incoming signals from those cables are routed can be assigned appropriate translation modules 204 as well. If the cable carrying the RS-232 signal to data input port 148a is subsequently unplugged from data input port 148a, and a different cable from a sensor 102 that outputs data in an I²C format is plugged into data input port 148a, then a different translation module—one that will translate the I²C signal into an SPI (or any other desired) signal—can be assigned to pins 1-8. In short, setup of a sensor trap 100 for a particular sensor 102 or group of sensors 102 requires little more than connecting a cable from each sensor 102 to a data input port 148 on the sensor trap 100, and then assigning the appropriate translation module 204 to the pins 108 associated with the data input port 148 to properly translate the incoming signal to a desired output signal format. The data input ports 148 may be reconfigured with different types of physical connectors as needed based on the type of output provided by a sensor 102 to be connected to the sensor trap 100.

Further with respect to FIG. 2, according to some embodiments, the memory 136 of the sensor trap 100 also stores a translation module selector 208 comprising instructions for causing the processor 104 to compare the incoming signal(s) received at a particular data input port 148 to a database of known signal formats and/or protocols, and to automatically select a subset of potentially applicable translation modules 204 to use in converting the incoming signal(s). A user may then select a specific translation module 204 from among the subset of translation modules 204 for use with the signal in question. In other embodiments, the translation module selector 208 comprises instructions for conducting the same type of comparison and for automatically selecting a particular translation module 204 to use in converting the incoming signal(s). In further embodiments, the memory 136 of the sensor trap 100 stores instructions for automatically selecting a particular translation module 24 based on the data input port 148 at which the incoming signal(s) are received. In such embodiments, the translation modules may be permanently or semi-permanently assigned to specific data input ports 148. In still further embodiments, a user manually selects a translation module 204 from the plurality of translation modules 204 stored in the memory 136 of the sensor trap 100 to use in converting the incoming signal(s), whether by adjusting a setting with a computing device connected to the programming port 112 or by using the control button 116. In various embodiments, additional translation modules 204 can be uploaded to the memory 136 of the sensor trap 100 to enhance the functionality and usefulness of the configurable sensor trap 100.

Additionally, the data storage area 144 of the memory 136 may store sensor data 212 received from the one or more sensors 102 to which the sensor trap 100 is connected. The sensor data 212 may comprise data collected by the sensor over a period of time, and may be periodically transmitted to a data sink/router (whether directly or indirectly), from which it can be uploaded to the cloud and/or sent to another network location. Depending on the capacity of the memory 136, the sensor data 212 may be transmitted to a data sink/router multiple times per day, or daily, or once every plurality of days, or once a week, or on any other suitable time period. Additionally, the sensor data 212 may be deleted once it has been transmitted to the data sink/router, to make room for new sensor data 212. In some embodiments, the processor 104 may be configured to perform one or more mathematical computations on the sensor data 212, and to store the results of the mathematical computations in the memory 136 while deleting the underlying sensor data 212. For example, if a temperature sensor takes a temperature reading once every minute, then rather than storing every data point provided by the temperature sensor, the processor 104 may calculate an average temperature over each hour, and store only the average temperature for each hour in the memory 136. Alternatively, to conserve processing and network resources, the sensor trap 100 may store all of the data points received from a given sensor 102, but may transmit only an average of those data points, taken over a suitable time period (e.g., an average hourly temperature). As another example, the sensor trap 100 may transmit only trend information, and/or may transmit only data points that are different (whether non-identical or beyond a given margin or tolerance) from previous data points.

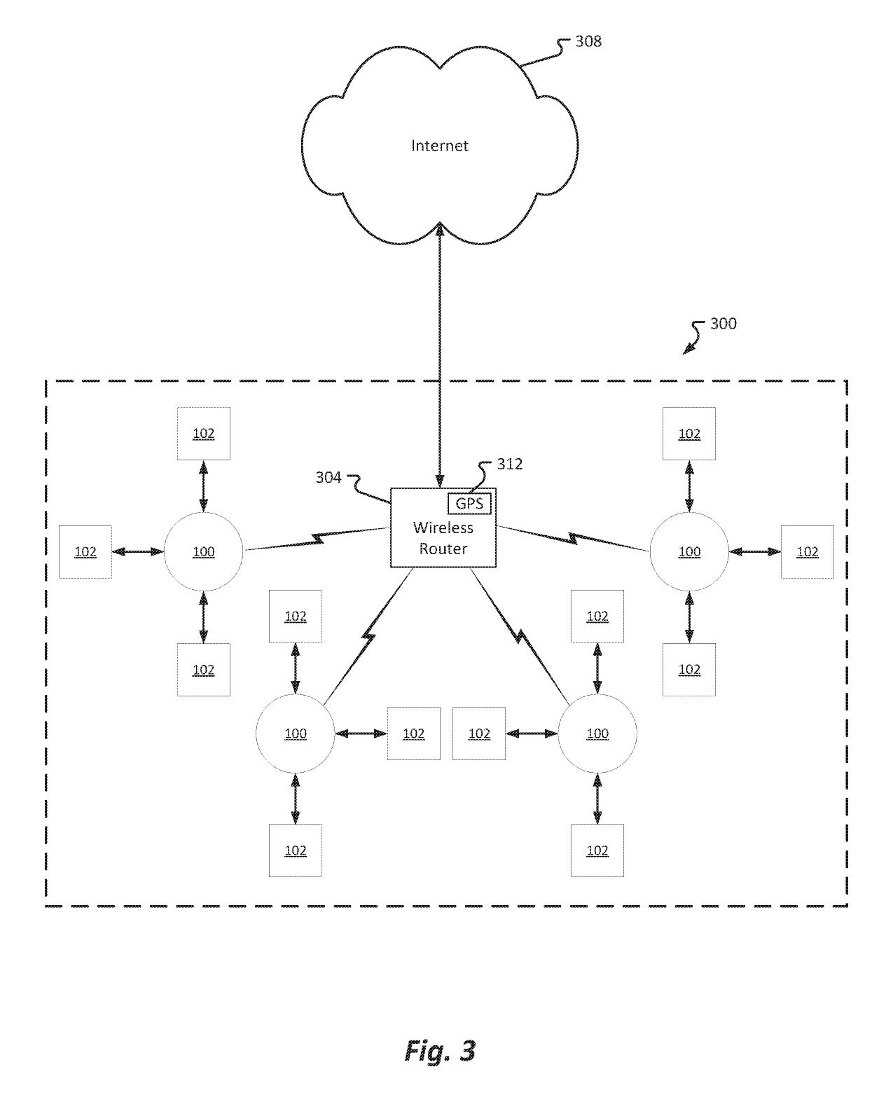

With reference now to FIG. 3, a configurable sensor trap 100 can be configured as a node in a mesh network 300, which may comprise a plurality of sensor traps 100. Each sensor trap 100 receives raw or nearly raw (if conditioned by a signal conditioner 101) data from a sensor 102, converts it into a real-world value or another useable value, then makes the data available on the mesh network 300, whether by sending the data to other nodes of the mesh network 300 via the communication interface 132, or allowing the data to be accessed by or otherwise read by other nodes of the mesh network 300. In the embodiment of FIG. 3, each sensor trap 100 sends the data received from the sensors 102 connected thereto to a gateway in the mesh network (wireless router 304), through which the data can be uploaded to the Internet 308 and made accessible from anywhere Internet access is available. Although the mesh network 300 is depicted with this structure, one or more of the sensor traps 100 may be located outside of communication range with the wireless router 304, and may therefore transmit the data received from the sensors 102 connected thereto to another sensor trap 100, which may forward the data to the wireless router 304. In other embodiments, each sensor trap 100 may broadcast the data received from the sensors 102 connected thereto, and each node of the mesh network 300 that receives the broadcast may forward the data to the wireless router (whether directly or through one or more additional broadcasts) until the data has reached the wireless router 304.

In accordance with other embodiments of the present disclosure, a wearable mobile device may be configured as a sensor trap like the sensor trap 100, such that it operates as (or provides data directly to) a node in a mesh network such as the mesh network 300. As used herein, wearable mobile devices are devices having a processor (like the processor 104) and a memory (like the memory 136), which devices are intended to be held or worn by a user, and which devices may include, without limitation, smartphones, tablets, watches, wristbands, necklaces, pendants, glasses, clothing, belts, fobs, and so forth. Wearable mobile devices often include one or more sensors (like the sensors 102), such as accelerometers, pedometers, biometric sensors, optical sensors, audio sensors, location sensors, signal strength indicators, and so forth. When a wearable mobile device is configured as a sensor trap, information from sensors on the wearable device can be transmitted across the mesh network to the router/gateway of the mesh network, and then on to a central server via the cloud for monitoring.

In some embodiments, the router/gateway 304 of the mesh network 300 includes a positioning device 312, such as a GPS unit. Because a mesh network node is necessarily within the range of the mesh network 300 serviced by the router 304 as long as it is communicating over the mesh network 300, the location of the router 304 can be used to determine the approximate location of the node. For example, if an employee of a company that administers the mesh network 300 is wearing a wearable mobile device that acts as a node in the mesh network 300 and communicates with the router 304, then the location of the router 304 may be used to determine the approximate location of the wearable mobile device and therefore of the employee. Alternatively, a wearable mobile device or other node of the mesh network 300 may itself including a positioning device, and may report its location to the router 304 (which may then pass the location of the node to a central server or other receiving device via the Internet 308).

Although the foregoing description has focused on the use of a sensor trap 100 to translate signals received from sensors 102 from an input format to an output format and to send the translated data across a mesh network 300 to a data sink/router (such as the wireless router 304), it should be appreciated that the sensor trap 100 can also be used to translate commands received via a mesh network 300 (e.g. over the communication interface 132 of the sensor trap 100) from a first format to a second, sensor-specific format. In some embodiments, the same translation module 204 that converts incoming sensor signals from an input format to an output format also includes instructions for converting command signals received at the wireless communication interface 132 from a received format to a sensor-specific signal format, so that the command can be sent to the sensor 102 by the processor 104 via the data input port 148. In other embodiments, the memory 136 of the sensor trap 100 stores one or more translation modules that include instructions only for converting incoming command signals into a sensor-specific signal format. As with other translation modules disclosed herein (e.g. the translation modules 204), translation modules configured to translate incoming command signals into a sensor-specific signal format can be dynamically assigned to an appropriate pin or pins 108 as needed to ensure that signal translation occurs properly for any given sensor 102.

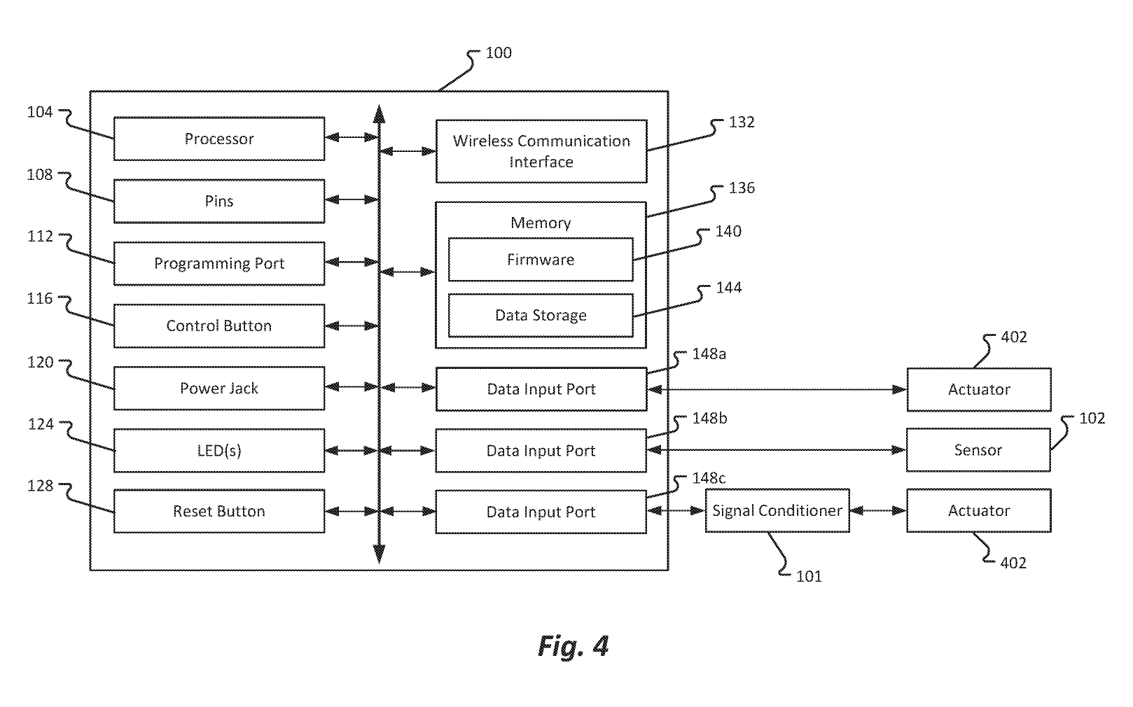

With reference now to FIG. 4, it should also be appreciated that the present disclosure is applicable to the control of multiple actuators 402 in a system as well. More specifically, a sensor trap 100 as disclosed herein may be connected to one or more actuators 402 in a system and used both to transmit commands received via the Internet to the actuator 402 (with appropriate translation by a translation module in the memory 136 of the sensor trap 100) and to allow feedback to be sent from the actuator 402 to a receiving device via the Internet (again with appropriate translation by a translation module in the memory 136 of the sensor trap 100). As with signals received from a sensor 102, if any signal conditioning is needed to render the signals from an actuator 402 readable by the sensor trap 100, or to render signals from the sensor trap 100 readable by an actuator 402, that conditioning may be done with a signal conditioner 101 before the signal reaches the data input port 148 of the sensor trap 100 (if sent from the actuator 402 to the sensor trap 100) or before the signal reaches the actuator 402 (if sent from the sensor trap 100 to the actuator 402).

Actuators 402 may be or include, for example, switches, valves, servos, motors, hydraulic actuators, pneumatic actuators, linear actuators, electric actuators, thermal actuators, and magnetic actuators. The use of one or more sensor traps 100 with actuators 402 may be used to facilitate the control of devices or systems remotely, thus allowing for the conservation of resources associated with maintaining an in-person presence for local control of devices or systems.

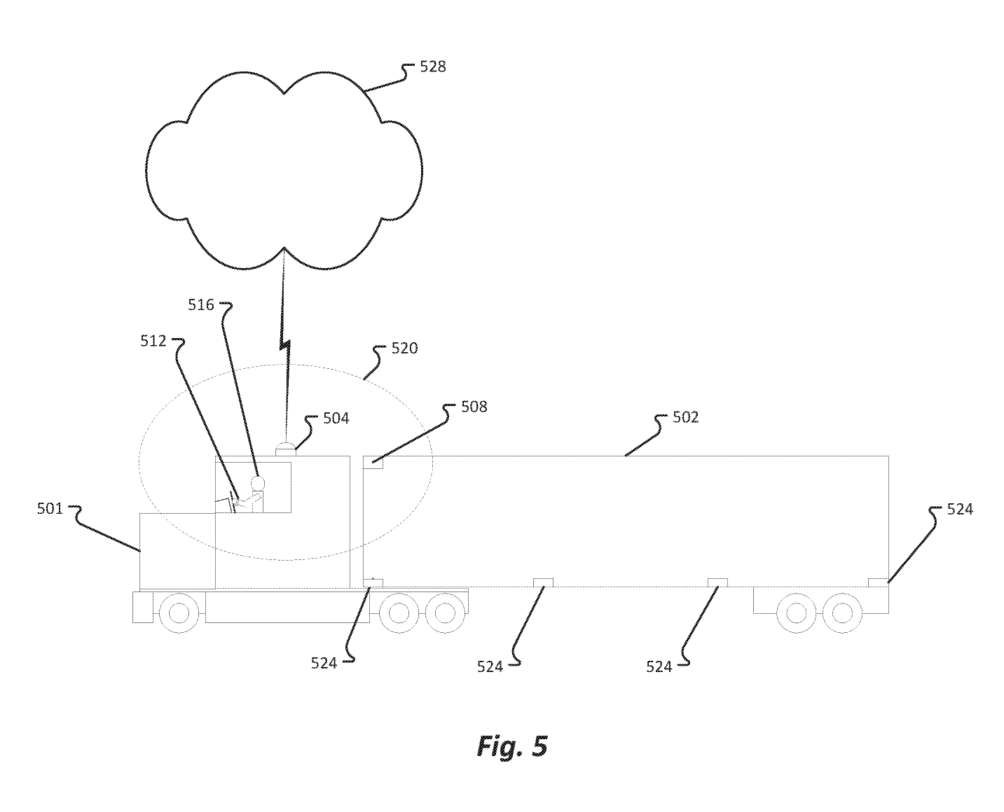

Turning now to FIG. 5, according to one embodiment of the present disclosure, a trucking company may equip each tractor 501 in its truck fleet with a gateway 504 comprising a GPS or other positioning system. The gateway 504 may be powered, for example, by the existing electrical system of the tractor 501, and/or by a separate power source (e.g. a battery, a solar cell, a wind-driven generator, or a combination of an energy generation device and an energy storage device). In some embodiments, the gateway 504 may be positioned on top of the tractor 501, while in other embodiments the gateway 504 may be positioned elsewhere on the tractor 501. The gateway 504 may be equipped with a wireless communication interface that allows the gateway 504 to connect to the cloud 528 via one or more cellular networks and/or satellite networks, using any now known or future developed protocol useful for communicating via a cellular network and/or a satellite network, respectively (including, for example, GSM, GPRS, CDMA, EV-DO, EDGE, UMTS, and TCP/IP). The gateway 504 forms part of, and provides cloud connectivity to, a mesh network 520.

The trucking company may also equip each trailer 502 in its fleet with one or more sensor traps 508. The sensor traps 508 (which may have the same or similar components to the sensor trap 100 described previously) may be connected to one or more sensors 524 located throughout the trailer 502. Each sensor trap 508 may have a serial number or other unique identifier associated therewith. The sensors 524 to which the sensor trap 508 is connected may be, for example, accelerometers, thermometers or other temperature sensors, light sensors, or any other sensors. In some embodiments, the sensors 524 may be provided directly on the trailer 502, while in other embodiments, one or more of the sensors 524 may be provided in or on freight or cargo being carried by the trailer 502. The various sensors 524 on or within the trailer 502 may be in wired or wireless connection to the sensor trap 508, which may in turn belong to the mesh network 520. In some embodiments, the trailer 502 may comprise a plurality of sensor traps 508, while in other embodiments, the sensors 524 in the trailer 502 may connect to a sensor trap on the tractor 501.

Additionally, each driver 516 employed by the trucking company may have a sensor trap like the sensor trap 100 in the form of a wearable mobile device 512. The wearable mobile device 512 may comprise one or more sensors (such as the sensors 102) that track, for example, a heart rate and an activity level (e.g. steps) of the employee 516. The wearable mobile device 512 may also belong to the mesh network 520.

Data from the GPS or other positioning system of the gateway 504, the sensors 524 (as received by the sensor trap 508), and the sensors of the wearable mobile device 512 may be provided to the trucking company via the gateway 504 and the cloud 528. The trucking company can then use this data for a variety of purposes. For example, the trucking company can identify the location of the tractor 501 at any given instance based on the GPS information provided by the gateway 504. The trucking company can verify that the truck driver is driving the appropriate tractor 501 with the appropriate trailer 502 by verifying that the truck driver's wearable mobile device 512 is part of the mesh network 520 serviced by the gateway 504, and that the serial numbers of the sensors 524 and sensor trap 508 (also available via the gateway 504) in the trailer 502 match those of the trailer assigned to be pulled by the tractor 501. Finally, the trucking company can verify that the truck driver 516 is in compliance with driver rest laws by verifying that the heart rate/activity level of the truck driver 516 demonstrates that the truck driver 516 was sleeping or otherwise resting for the required period of time within the previous day or other regulatory period. In some embodiments, the trucking company might use this data to provide suggested actions to the driver 516, e.g. to indicate to the driver 516 that his or her activity level is too low and to suggest that the driver 516 pull over at a nearby rest stop to do some physical activity.

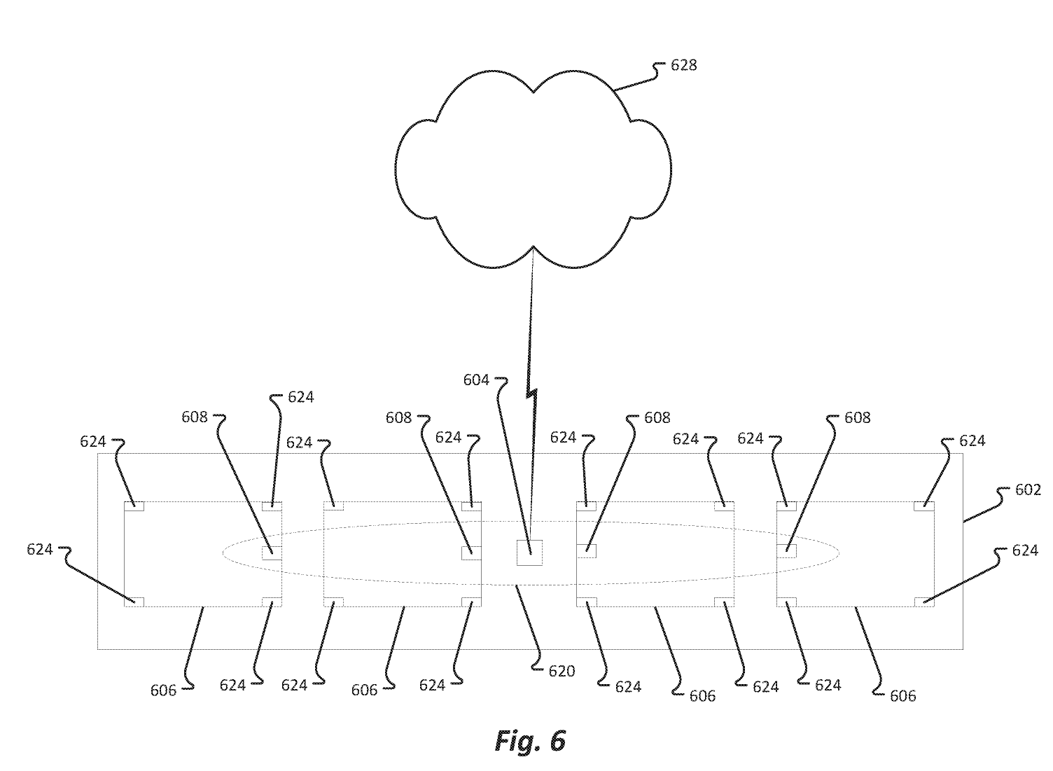

FIG. 6 illustrates another embodiment of the present disclosure, in which a plurality of machines 606 are positioned on a factory floor 602. Each machine 606 has a plurality of sensors 624. The sensors 624 may monitor, for example, one or more aspects of the machine 606 during operation. In some embodiments, one or more of the sensors 624 may be replaced by an actuator for controlling one or more aspects of the machine 606. Also in some embodiments, one or more of the machines 606 may have only one sensor 624. Although each machine 606 illustrated in FIG. 6 is shown with the same number of sensors 624, each machine 606 may have any number of sensors 624 (or any number of actuators, or a combination of any number of sensors 624 and any number of actuators). Additionally, each of the sensors 624 may be any kind of sensor. In other words, the sensors 624 need not be the same type of sensor.

Each sensor 624 on a given machine 606 of FIG. 6 is connected to a configurable sensor trap 608 associated with the machine 606. The configurable sensor trap may be the same as or similar to the configurable sensor traps described herein, including the configurable sensor trap 100. In some embodiments, a given machine 606 may have a plurality of configurable sensor traps associated therewith, even though FIG. 6 depicts only a single configurable sensor trap 608 associated with each machine 606. The number of configurable sensor traps associated with a machine 606 may be determined, for example, by the number of sensors 624 on or associated with the machine 606. In some embodiments, one configurable sensor trap 608 of a given machine 606 may be connected to one or more sensors 624 on the machine 606, and another configurable sensor trap may be connected to one or more actuators on the machine 606. In other embodiments, each configurable sensor trap 608 on a machine 606 may be connected to all of the same types of sensors 624 on the machine 606. For example, if a machine 606 has four temperature sensors, three pressure sensors, and five motion sensors, then the machine 606 may comprise three configurable sensor traps, one each for the temperature sensors, the pressure sensors, and the motion sensors. As described elsewhere herein, however, each configurable sensor trap 608 may be connected to more than one type of sensor 624, and/or to more than one type of actuator.

Each of the configurable sensor traps 608 is a node on the mesh network 620, and is in communication with the gateway 604. The gateway 604 is, in turn, in communication with the cloud 628. Thus, information gathered by the various sensors 624 associated with each machine 606 is provided to the configurable sensor trap 608 associated with the machine 606, which transmits the information (or corresponding information) to the gateway 604, which in turn transmits the information (or corresponding information) to the cloud 628. Once the information (or corresponding information) is in the cloud 628, it may be accessed by anyone with Internet access and the proper credentials, such that operation of the machines 606 may be monitored by anyone with proper credentials and from anywhere with Internet access. Additionally, data regarding the operation of the machines 606 may be retrieved by a central server also connected to the cloud, and analyzed (whether on a per-machine basis, a per-factory basis, a company-wide basis, or any other suitable basis) for useful information, including but not limited to information regarding machine efficiency, machine operation, factory efficiency, machine output, and factory output.

As can be seen from the above description, configurable sensor traps as disclosed herein are useful for quickly connecting sensors or actuators having a plurality of input/output signal formats to a mesh network and/or to the Internet. Configurable sensor traps may be used with a wide variety of sensors and actuators, and therefore reduce the need for the design and manufacture of sensor- or actuator-specific traps. Configurable sensor traps also allow for conservation of resources by reducing the amount of time, effort, and money needed to connect a sensor or actuator system to a mesh network and/or to the cloud. Although aspects of the present disclosure have been discussed in the context of trucking and factories, the present disclosure may be implemented in any context where one or more sensors and/or actuators are used.

Specific details were given in the foregoing description to provide a thorough understanding of the embodiments. However, it will be understood by one of ordinary skill in the art that the embodiments may be practiced without these specific details. Persons of ordinary skill in the art will also understand that various embodiments described above may be used in combination with each other without departing from the scope of the present disclosure. In this disclosure, well-known circuits, processes, algorithms, structures, hardware, and techniques have been shown and described without unnecessary detail in order to avoid obscuring the embodiments.

To avoid unnecessarily obscuring the present disclosure, the preceding description omits a number of known structures and devices. This omission is not to be construed as a limitation of the scopes of the claims. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Any of the steps, functions, and operations discussed herein can be performed continuously and automatically.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJS™ processors, and other industry-equivalent processors. A processor as disclosed herein may perform computational functions using any known or future-developed standard, instruction set, libraries, and/or architecture.

What is claimed is:

1. A configurable sensor trap, comprising:
a processor comprising a plurality of pins,
at least one port having at least one conducting channel for receiving an incoming signal in one of a plurality of first formats, the conducting channel electrically coupled to at least one of the plurality of pins;
a memory storing a plurality of translation modules, each translation module containing instructions for causing the processor to translate a signal from one of the plurality of first formats to a second format, each translation module dynamically associable with at least one of the plurality of pins; and
a communication interface for transmitting signals in the second format across a network.

2. The configurable sensor trap of claim 1, wherein the communication interface is configured to receive command signals in a third format from the network and the plurality of translation modules includes at least one translation module containing instructions for causing the processor to translate the command signals from the third format to one of the plurality of first formats.

3. The configurable sensor trap of claim 1, wherein the plurality of first formats comprises RS-232, Modbus, Interbus, or CAN bus.

4. The configurable sensor trap of claim 1, wherein the second format comprises SPI.

5. The configurable sensor trap of claim 1, wherein the at least one port is an RJ45 port.

6. The configurable sensor trap of claim 1, further comprising a plurality of ports, each of the plurality of ports having a plurality of conducting channels.

7. The configurable sensor trap of claim 6, wherein each of the plurality of conducting channels is electrically coupled to one of the plurality of pins.

8. The configurable sensor trap of claim 1, wherein the memory further stores instructions for causing the processor to automatically associate one of the plurality of translation modules with the at least one of the plurality of pins electrically coupled to the conducting channel based upon an evaluation of the incoming signal.

9. The configurable sensor trap of claim 8, wherein the evaluation of the incoming signal comprises comparing a format of the incoming signal to each of the plurality of first formats.

10. The configurable sensor trap of claim 9, wherein the memory further stores a database of the plurality of first formats.

11. A sensor system comprising:
a plurality of sensors; and
at least one sensor trap, the sensor trap comprising:
a processor comprising a plurality of pins,
a plurality of ports, each of the plurality of ports electrically coupled to one of the plurality of sensors, each port having a plurality of conducting channels for receiving an incoming signal in one of a plurality of first formats from one of the plurality of sensors, each of the plurality of conducting channels electrically coupled to one of the plurality of pins;
a memory storing a plurality of translation modules, each translation module containing instructions for causing the processor to translate a signal from one of the plurality of first formats to a second format, wherein one of the plurality of translation modules is dynamically associated with each pin that is electrically coupled to one of the plurality of conducting channels; and
a communication interface for transmitting signals in the second format across a network.

12. The sensor system of claim 11, wherein at least one sensor trap further comprises at least one actuator port electrically coupled to at least one actuator.

13. The sensor system of claim 11, wherein the communication interface is configured to receive command signals in a third format from the network and the plurality of translation modules includes at least one translation module containing instructions for causing the processor to translate the command signals from the third format to one of the plurality of first formats.

14. The sensor system of claim 11, wherein the plurality of first formats comprises RS-232, Modbus, Interbus, or CAN bus.

15. The sensor system of claim 11, wherein the second format comprises SPI.

16. The sensor system of claim 11, wherein at least one of the plurality of ports is an RJ45 port.

17. The sensor system of claim 11, wherein the plurality of sensors includes at least one of a temperature sensor, a pressure sensor, an audio sensor, an optical sensor, a motion sensor, a location sensor, a chemical sensor, and a biometric sensor.

18. The sensor system of claim 11, wherein the network is connected to the Internet.

19. An end node of a mesh network, comprising:
a transceiver for sending signals across and receiving signals from a mesh network;
a processor comprising a plurality of pins, each pin dynamically associable with one of a plurality of translation modules stored in a memory, each translation module containing instructions for causing the processor to translate a signal from an input format to an output format; and
a sensor or an actuator electrically coupled to at least one of the plurality of pins via a port.

20. The end node of claim 19, wherein signals received from the sensor or the actuator in the input format are translated to the output format and sent across the mesh network by the transceiver, and signals received by the transceiver from the mesh network in the output format are translated to the input format and sent to the sensor or the actuator.
